(19) United States
(12) Patent Application Publication
(10) Pub. No.: US 2020/0126102 A1
(43) Pub. Date: Apr. 23, 2020

(54) ASSET MANAGEMENT

(71) Applicant: International Business Machines Corporation, Armonk, NY (US)

(72) Inventors: Schayne Bellrose, Poughkeepsie, NY (US); Pasquale A. Catalano, Wallkill, NY (US); Nicholas Crimmins, Montrose, NY (US); Preston Lane, Poughkeepsie, NY (US)

(21) Appl. No.: 16/167,909

(22) Filed: Oct. 23, 2018

(51) Int. Cl. G06Q 30/02; G06Q 50/00; H04L 29/08

(52) U.S. Cl. CPC G06Q 30/0206; G06Q 50/01; G06Q 30/0284; G06Q 30/0226; H04L 67/306

(57) ABSTRACT

According to examples of the present disclosure, a computer-implemented method includes determining a gross value for the digital asset, the digital asset being associated with a user. The method further includes modifying the gross value to generate a modified value. The modified value is based at least in part on a user profile and a social media trend. The user profile defines a user preference indicative of a personal value of the digital asset to the user. The social media trend is indicative of a market value of the digital asset to a group of users. The method further includes reducing the modified value by an asset acquisition cost to determine a digital asset net value. The method further includes comparing the digital asset net value to a user value. The method further includes acquiring the digital asset when the digital asset net value exceeds the user value.

### BACKGROUND

The present invention generally relates to processing systems, and more specifically, to asset management.

Assets can be valued or appraised to determine a worth of the asset. For example, a value can be determined for tangible assets (e.g., real estate, automobiles, securities, etc.) and intangible assets (e.g., patents and trademarks).

### SUMMARY

Embodiments of the present invention are directed to a computer-implemented method for asset management of a digital asset. A non-limiting example of the computer-implemented method includes determining, by a processing device, a gross value for the digital asset, the digital asset being associated with a user. The method further includes modifying, by the processing device, the gross value to generate a modified value, the modified value being based at least in part on a user profile and a social media trend, the user profile defining a user preference indicative of a personal value of the digital asset to the user, and the social media trend indicative of a market value of the digital asset to a group of users. The method further includes reducing, by the processing device, the modified value by an asset acquisition cost to determine a digital asset net value. The method further includes comparing, by the processing device, the digital asset net value to a user value. The method further includes responsive to determining that the digital asset net value exceeds the user value, acquiring the digital asset.

Embodiments of the present invention are directed to a system. A non-limiting example of the system includes a memory comprising computer readable instructions and a processing device for executing the computer readable instructions for performing a method for asset management of a digital asset. A non-limiting example of the method for asset management of a digital asset.

Embodiments of the invention are directed to a computer program product. A non-limiting example of the computer program product includes a computer readable storage medium having program instructions embodied therewith. The program instructions are executable by a processor to cause the processor to perform a method for asset management of a digital asset. A non-limiting example of the method for asset management of a digital asset.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments described herein;

FIG. 2 depicts abstraction model layers according to one or more embodiments described herein;

FIG. 3 depicts a block diagram of a processing system for implementing the presently described techniques according to one or more embodiments described herein;

FIG. 4 depicts a block diagram of a host processing system for asset management of a digital asset according to one or more embodiments described herein;

FIG. 5 depicts a flow diagram of a method for asset management of a digital asset according to one or more embodiments described herein; and

FIG. 6 depicts a flow diagram of a method for asset management of a digital asset according to one or more embodiments described herein.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that, although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

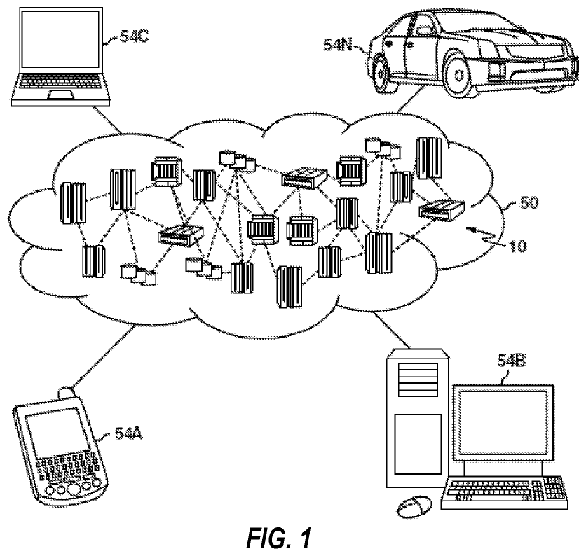

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

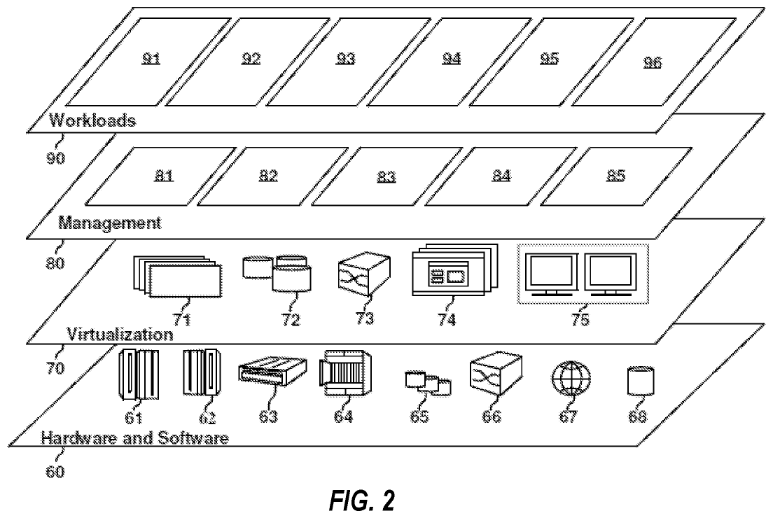

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and digital asset appraisal 96.

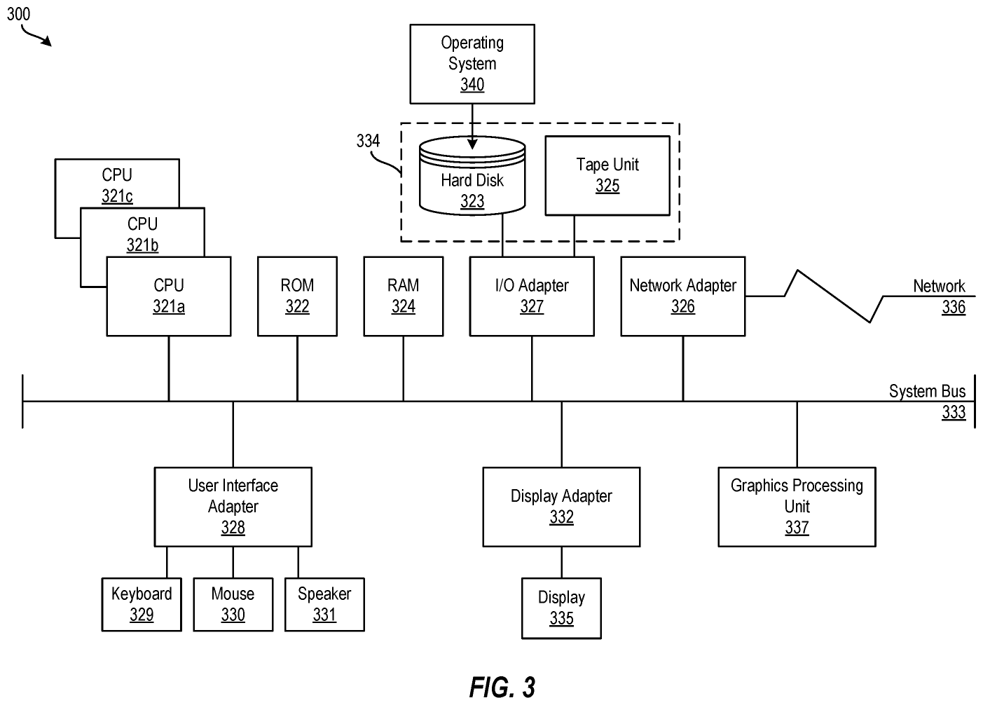

It is understood that the present disclosure is capable of being implemented in conjunction with any other type of computing environment now known or later developed. For example, FIG. 3 depicts a block diagram of a processing system 300 for implementing the techniques described herein. In examples, processing system 300 has one or more central processing units (processors) 321a, 321b, 321c, etc. (collectively or generically referred to as processor(s) 321 and/or as processing device(s)). In aspects of the present disclosure, each processor 321 can include a reduced instruction set computer (RISC) microprocessor. Processors 321 are coupled to system memory (e.g., random access memory (RAM) 324) and various other components via a system bus 333. Read only memory (ROM) 322 is coupled to system bus 333 and may include a basic input/output system (BIOS), which controls certain basic functions of processing system 300.

Further depicted are an input/output (I/O) adapter 327 and a network adapter 326 coupled to system bus 333. I/O adapter 327 may be a small computer system interface (SCSI) adapter that communicates with a hard disk 323 and/or a tape storage drive 325 or any other similar component. I/O adapter 327, hard disk 323, and tape storage device 325 are collectively referred to herein as mass storage 334. Operating system 340 for execution on processing system 300 may be stored in mass storage 334. The network adapter 326 interconnects system bus 333 with an outside network 336 enabling processing system 300 to communicate with other such systems.

A display (e.g., a display monitor) 335 is connected to system bus 333 by display adapter 332, which may include a graphics adapter to improve the performance of graphics intensive applications and a video controller. In one aspect of the present disclosure, adapters 326, 327, and/or 232 may be connected to one or more I/O busses that are connected to system bus 333 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 333 via user interface adapter 328 and display adapter 332. A keyboard 329, mouse 330, and speaker 331 may be interconnected to system bus 333 via user interface adapter 328, which may include, for example, a Super I/O chip integrating multiple device adapters into a single integrated circuit.

In some aspects of the present disclosure, processing system 300 includes a graphics processing unit 337. Graphics processing unit 337 is a specialized electronic circuit designed to manipulate and alter memory to accelerate the creation of images in a frame buffer intended for output to a display. In general, graphics processing unit 337 is very efficient at manipulating computer graphics and image processing, and has a highly parallel structure that makes it more effective than general-purpose CPUs for algorithms where processing of large blocks of data is done in parallel.

Thus, as configured herein, processing system 300 includes processing capability in the form of processors 321, storage capability including system memory (e.g., RAM 324), and mass storage 334, input means such as keyboard 329 and mouse 330, and output capability including speaker 331 and display 335. In some aspects of the present disclosure, a portion of system memory (e.g., RAM 324) and mass storage 334 collectively store an operating system such as the AIX® operating system from IBM Corporation to coordinate the functions of the various components shown in the processing system 300.

Turning now to an overview of technologies that are more specifically relevant to aspects of the invention, techniques for asset management of digital assets are provided. The acquisition and retention of digital assets are becoming more prevalent in the digital age. Determining the value of digital assets can be multi-faceted and is non-trivial. Digital assets are assets stored digitally and can be in the form of a digital coupon, rewards points, in-application collectibles, gameplay tokens/assets, and/or the like.

The present techniques provide for evaluating a digital asset and determining a net value for the digital asset. The net value can be determined based on considerations such as asset attributes, user preferences, trends in social media, acquisition costs, and/or the like. To do this, a gross value for the digital asset is determined. The gross value is modified to generate a modified value, which is based on a user profile and a social media trend. The user profile defines user preferences indicative of a personal value of the digital asset to the user, and the social media trend indicates a market value of the digital asset to a group of users. The modified value is reduced by an asset acquisition cost to determine a digital asset net value, which is then compared against a user value to determine whether to acquire (or sell) the digital asset.

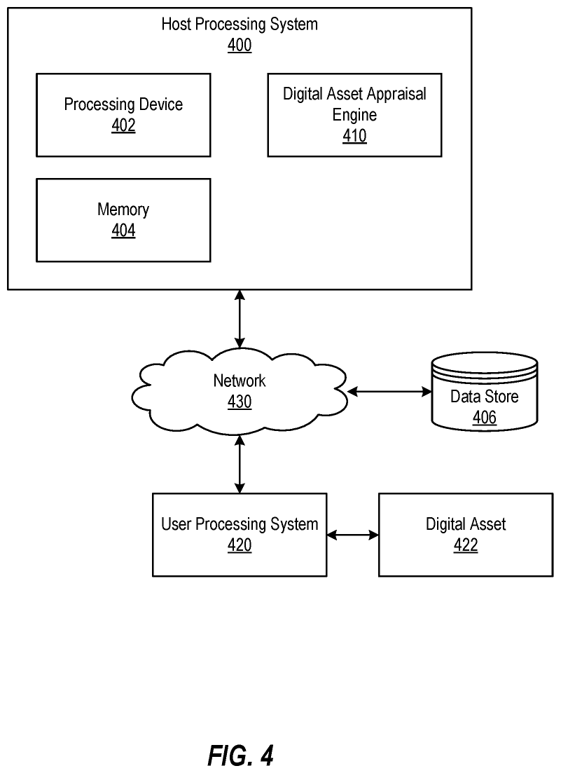

Turning now to a more detailed description of aspects of the present invention, FIG. 4 depicts a block diagram of a host processing system 400 for asset management of a digital asset according to one or more embodiments described herein. The host processing system 400 includes a processing device 402, a memory 404, and a digital asset appraisal engine 410. The host processing system 400 is communicatively coupled to a user processing system 420 either directly or indirectly, such as via a network 430. A data store 406 for storing data is also communicatively coupled to the host processing system 400 and/or the user processing system 420 directly or indirectly via the network 430.

The various components, modules, engines, etc. described regarding FIG. 4 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 402 for executing those instructions. Thus a system memory (e.g., the memory 404) can store program instructions that when executed by the processing device 402 implement the engines described herein. Other engines can also be utilized to include other features and functionality described in other examples herein.

It should be appreciated that the network 430 can be any suitable communication infrastructure for connecting processing systems, such as the host processing system 400 and the user processing system 420, and other electronic devices. The network 430 may include various networking devices and appliances such as switches, routers, hubs, access points, and/or the like, and the network 430 can include wired and/or wireless capabilities.

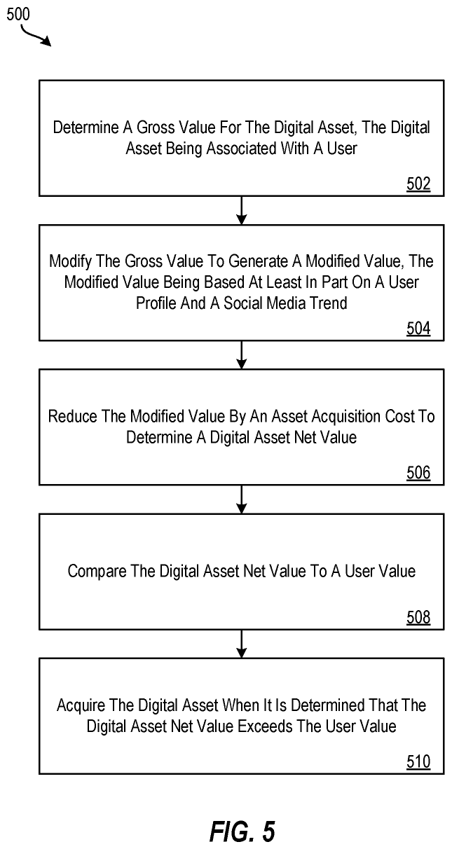

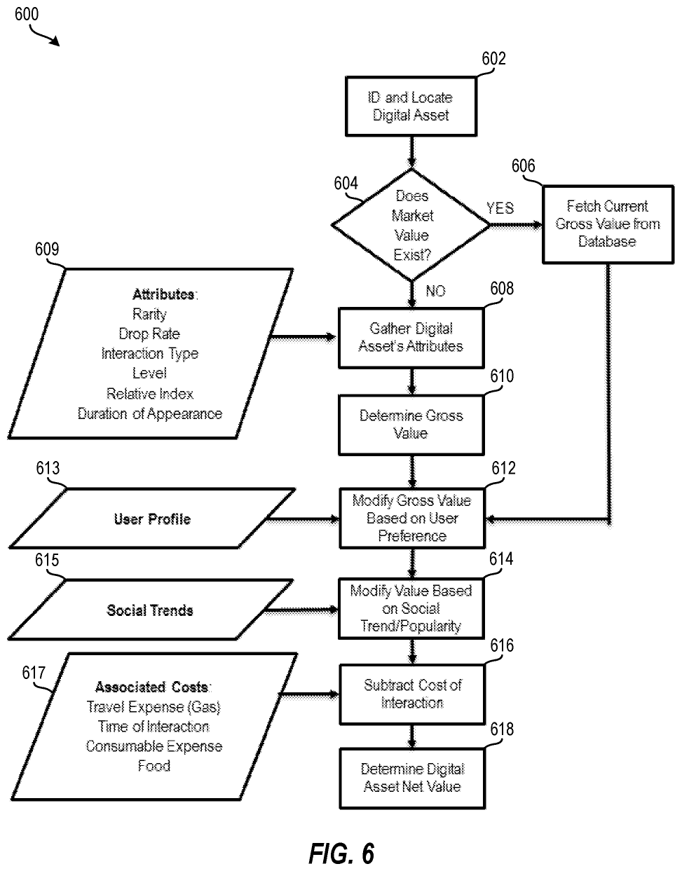

The digital asset appraisal engine 410 appraises/values digital assets, such as the digital asset 422. For example, the digital asset appraisal engine 410 determines a digital asset net value of a digital asset 422. The digital asset net value is the value associated with the digital asset 422 with considerations of the gross value, user preferences, social media trends, and costs of the digital asset 422. The features and functionality of FIG. 4 are now described with more detail regarding FIGS. 5 and 6.

FIG. 5 depicts a flow diagram of a method 500 for asset management of a digital asset according to one or more embodiments described herein. The method 500 can be performed by any suitable processing system (e.g., the cloud computing environment 50, the processing system 300, the host processing system 400, etc.) and/or processing device (e.g., the processing device 321, the processing device 402, etc.).

At block 502, the digital asset appraisal engine 410 determines a gross value for the digital asset 422. The digital asset 422 is associated with a user and can be an electronic ticket to an event, a rewards program credit, frequent flyer miles, a gameplay asset, and/or the like. For example, the user may currently possess or have ownership rights in the digital asset 422 or the user may desire to possess or have ownership rights in the digital asset 422. The gross value can be determined based on asset attributes of the digital asset 422. In an example in which the digital asset 422 is a gameplay asset, such as a virtual creature, asset attributes used to determine the gross value of the digital asset 422 can include a rarity, an interaction type, a level, a relative index, a duration of appearance, and/or the like. In an example in which the digital asset 422 is a digital coupon, the gross value can be determined using asset attributes such as expiration date, face value, distance to a nearest store that accepts the digital coupon, price of an item with which the coupon is associated, etc. In an example in which the digital asset 422 is airline miles, the gross value can be determined using asset attributes such as airline, redemption rate, expiration date, etc. In some examples, the gross value can be retrieved from a database of values (e.g., the data store 406) based on a marketplace or exchange. For example, if a marketplace or exchange exists for the digital asset 422, the gross value can be based on a value (e.g., a lowest value, a highest value, a mean or median value, etc.) of a similar digital asset on the marketplace or exchange.

At block 504, the digital asset appraisal engine 410 modifies the gross value of the digital asset 422 (from block 502) to generate a modified value of the digital asset. The modified value is based on a user profile and a social media trend, for example. The user profile defines a user preference indicative of a personal value of the digital asset 422 to the user. The user preference can be, for example, a sentimental value of the user for the digital asset 422, a preference to use a particular airline or shop at a particular store, etc. For example, if a user preference indicates that the user has a sentimental attachment to the digital asset 422, the gross value of the digital asset 422 is increased. The social media trend indicates a market value of the digital asset to a group of users (e.g., friends/connections of the user, a group of individuals interested in the digital asset 422, etc.) determined by monitoring one or more social networking services to determine a popularity/desire and/or an availability of the digital asset. For example, if a social media trend indicates a low demand and/or high availability of the digital asset 422, the gross value of the digital asset 422 is decreased.

At block 506, the digital asset appraisal engine 410 reduces the modified value (from block 504) by an asset acquisition cost to determine a digital asset net value for the digital asset 422. In some cases, there is a cost associated with acquiring the digital asset. For example, if the user has to travel to acquire the digital asset 422, costs associated with acquiring the digital asset can include travel expenses such as gas, airfare, bus fare, tolls, etc. Other costs can include the user's time and other consumable expenses (e.g., meals, taxes, transfer fees, etc.) associated with acquiring the digital asset 422. The digital asset net value is determined by subtracting the asset acquisition costs from the modified value to determine a digital asset net value for the digital asset 422.

At block 508, the digital asset appraisal engine 410 compares the digital asset net value (from block 506) to a user value. The user value is set by the user and is indicative of how much the user values the digital asset 422. For example, the user can set a user value of $40 for a particular digital asset 422. In this case, the digital asset appraisal engine 410 compares the digital asset net value to the user value of $40. If the digital asset net value is $40 or more, the digital asset appraisal engine 410 enables the user to acquire the digital asset at block 510. In some cases, the digital asset appraisal engine 410 can enable the user processing system 420 to acquire the digital asset 422 automatically on behalf of the user. For example, the user processing system 420 can automatically download the digital asset 422. If the digital asset net value does not exceed the user value, the user may be alerted not to acquire the digital asset 422.

Additional processes also may be included. In some examples, the digital asset appraisal engine 410 can monitor social media trends across one or more social networking services and can update the digital asset net value based on changes in social media trends. For example, social sentiment towards a digital asset may increase over time (e.g., evidenced by increased discussion of the digital asset on a social networking service). In such cases, the digital asset net value can be increased to reflect the change to the social media trend. Monitoring social media trends of a digital asset is a problem unique to the Internet, and, accordingly, updating the digital asset net value based on changes to the social media trends represents an improvement to computer functionality.

It should be understood that the process depicted in FIG. 5 represents an illustration, and that other processes may be added or existing processes may be removed, modified, or rearranged without departing from the scope and spirit of the present disclosure.

FIG. 6 depicts a flow diagram of a method 600 for asset management of a digital asset according to one or more embodiments described herein. The method 600 can be performed by any suitable processing system (e.g., the cloud computing environment 50, the processing system 300, the host processing system 400, etc.) and/or processing device (e.g., the processing device 321, the processing device 402, etc.).

At block 602, the digital asset 422 is identified and located. At decision block 604, it is determined whether a marketplace or exchange for the digital asset 422 exists. If so, a gross value is retrieved from a database (e.g., the data store 406) of the marketplace or exchange at block 606. However, if it is determined that no marketplace or exchange exists, asset attributes 609 for the digital asset are collected at block 608. The asset attributes 609 can vary depending on the type of digital asset. In an example in which the digital asset 422 is a gameplay asset, such as a virtual creature, asset attributes used to determine the gross value of the digital asset 422 can include a rarity, an interaction type, a level, a relative index, a duration of appearance, and/or the like. At block 610, the gross value of the digital asset 422 is determined based on the asset attributes.

Once the gross value is determined, the gross value is modified based on user preferences 613 at block 612. The user preferences can include a sentimental value of the user for the digital asset 422, a preference to use a particular airline or shop at a particular store, etc. At block 614, the gross value is further modified based on a social media trend 615. The social media trend 615 indicates a market value of the digital asset to a group of users determined by monitoring one or more social networking services to determine a popularity/desire and/or an availability of the digital asset.

At block 616, costs 617 of acquiring the digital asset are subtracted from the modified value determined at block 612, 614. Costs 617 can include travel expenses, time expenses, consumable expenses, food expenses, and/or the like. Costs 617 can also include a cost to transfer the asset from one user to another user (e.g., a transfer fee/tax). At block 618, the digital asset net value is determined. The digital asset net value is the value associated with the digital asset 422 with considerations of the gross value, user preferences, social media trends, and costs of the digital asset 422. It can then be determined whether to acquire the digital asset 422 based on the digital asset net value. For example, the digital asset 422 can be acquired when the digital asset net value exceeds a user value.

Additional processes also may be included, and it should be understood that the process depicted in FIG. 6 represents an illustration, and that other processes may be added or existing processes may be removed, modified, or rearranged without departing from the scope and spirit of the present disclosure.

Example embodiments of the disclosure include or yield various technical features, technical effects, and/or improvements to asset management technology. Example embodiments of the disclosure provide an asset management system configured to determine a digital asset net value based at least in part on a gross value of the digital asset, asset attributes, user preferences, social media trends, and costs associated with acquiring the digital asset. These aspects of the disclosure constitute technical features that yield the technical effect of managing assets according to trends in social media, asset attributes, user preferences, and acquisition costs. For example, the techniques described herein apply social media trends to determine asset value. As a result of these technical features and technical effects, an asset management system in accordance with example embodiments of the disclosure represents an improvement to existing asset management techniques. It should be appreciated that the above examples of technical features, technical effects, and improvements to technology of example embodiments of the disclosure are merely illustrative and not exhaustive.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for asset management of a digital asset, the method comprising:
determining, by a processing device, a gross value for the digital asset, the digital asset being associated with a user;
modifying, by the processing device, the gross value to generate a modified value, the modified value being based at least in part on a user profile and a social media trend, the user profile defining a user preference indicative of a personal value of the digital asset to the user, and the social media trend indicative of a market value of the digital asset to a group of users;
reducing, by the processing device, the modified value by an asset acquisition cost to determine a digital asset net value;
comparing, by the processing device, the digital asset net value to a user value; and
responsive to determining that the digital asset net value exceeds the user value, acquiring the digital asset.

2. The computer-implemented method of claim 1, wherein determining the gross value for the digital asset is based at least in part on a current value as determined by a marketplace for the digital asset.

3. The computer-implemented method of claim 1, wherein determining the gross value for the digital asset is based at least in part on an asset attribute associated with the digital asset.

4. The computer-implemented method of claim 3, wherein the asset attribute associated with the digital asset is at least one of a rarity, an interaction type, a level, a relative index, or a duration of appearance.

5. The computer-implemented method of claim 1, wherein the asset acquisition cost is at least one of a travel expense, a time expense, or a consumable expense.

6. The computer-implemented method of claim 1, wherein the digital asset is an electronic ticket to an event.

7. The computer-implemented method of claim 1, wherein the digital asset is a rewards program credit.

8. The computer-implemented method of claim 1, wherein the digital asset is a gameplay asset.

9. The computer-implemented method of claim 1, further comprising:
monitoring, by the processing device, the social media trend; and
updating, by the processing device, the digital asset net value based at least in part on changes to the social media trend.

10. A system comprising:
a memory comprising computer readable instructions; and
a processing device for executing the computer readable instructions for performing a method for asset management of a digital asset, the method comprising:
determining, by the processing device, a gross value for the digital asset, the digital asset being associated with a user;
modifying, by the processing device, the gross value to generate a modified value, the modified value being based at least in part on a user profile and a social media trend, the user profile defining a user preference indicative of a personal value of the digital asset to the user, and the social media trend indicative of a market value of the digital asset to a group of users;
reducing, by the processing device, the modified value by an asset acquisition cost to determine a digital asset net value;
comparing, by the processing device, the digital asset net value to a user value; and
responsive to determining that the digital asset net value exceeds the user value, acquiring the digital asset.

11. The system of claim 10, wherein determining the gross value for the digital asset is based at least in part on a current value as determined by a marketplace for the digital asset.

12. The system of claim 10, wherein determining the gross value for the digital asset is based at least in part on an asset attribute associated with the digital asset.

13. The system of claim 12, wherein the asset attribute associated with the digital asset is at least one of a rarity, an interaction type, a level, a relative index, or a duration of appearance.

14. The system of claim 10, wherein the asset acquisition cost is at least one of a travel expense, a time expense, or a consumable expense.

15. The system of claim 10, wherein the digital asset is an electronic ticket to an event.

16. The system of claim 10, wherein the digital asset is a rewards program credit.

17. The system of claim 10, wherein the digital asset is a gameplay asset.

18. The system of claim 10, wherein the method further comprises:
monitoring, by the processing device, the social media trend; and
updating, by the processing device, the digital asset net value based at least in part on changes to the social media trend.

19. A computer program product comprising:
a computer readable storage medium having program instructions embodied therewith, the program instructions executable by a processing device to cause the processing device to perform a method for asset management of a digital asset, the method comprising:
determining, by the processing device, a gross value for the digital asset, the digital asset being associated with a user;
modifying, by the processing device, the gross value to generate a modified value, the modified value being based at least in part on a user profile and a social media trend, the user profile defining a user preference indicative of a personal value of the digital asset to the user, and the social media trend indicative of a market value of the digital asset to a group of users;
reducing, by the processing device, the modified value by an asset acquisition cost to determine a digital asset net value;
comparing, by the processing device, the digital asset net value to a user value; and
responsive to determining that the digital asset net value exceeds the user value, acquiring the digital asset.

20. The computer program product of claim 19, wherein the method further comprises:
monitoring, by the processing device, the social media trend; and
updating, by the processing device, the digital asset net value based at least in part on changes to the social media trend.
